(19) United States
(12) Patent Application Publication
(10) Pub. No.: US 2012/0126983 A1
(43) Pub. Date: May 24, 2012

(54) Method and associated device for personal weight control or weight loss

(76) Inventor: Joan Breibart, New York, NY (US)

(21) Appl. No.: 12/927,561

(22) Filed: Nov. 18, 2010

(51) Int. Cl. G08B 23/00

(52) U.S. Cl. 340/573.1

(57) ABSTRACT

A weight control method utilizes an electronic counting device. A counter in the device is incremented each time an input element is actuated or activated upon taking a bite of a comestible material. The counting device automatically provides an alert signal to the user upon attainment of a predetermined bite number in the counter. A display, such as a touch screen or an LCD or LED display provides a predetermined message depending on the number of bites recorded in the counter.

### BACKGROUND OF THE INVENTION

This invention relates to personal weight control/loss. More particularly, this invention relates to a method that a person may follow to reduce the intake or quantity of food consumed on a daily basis. This invention also relates to an associated device that a person may use to assist him or her in a weight control/loss program or method.

Clearly, the less food one consumes the fewer calories and carbohydrates and fat grams are consumed. But the most effective result of food consumption reduction is that it trains one to eat less so that the stomach and the body and the hand-to-mouth activity is altered so that one is actually unable to consume a lot. Food intake reduction trains one to be the opposite of a competitive eater.

There have been a plethora of different programs to assist individuals in losing weight. Such programs frequently entail diets of one kind or another. Weight-control diets may be quite complicated as to the kinds of foods and even the times of consumption such as not eating after 8 p.m. or always eating a big breakfast or eating a snack every two hours to maintain raised blood sugar levels. The weight-loss business essentially started in 1963 with Weight Watchers. Forty-seven years later and now 70% of the U.S. adult population is considered overweight/obese when the number in 1958 was less than 15%.

A more effective and useful weight control approach, which has the added value of saving the individual money, has the individual limit the amount of food consumed by simply counting the bites that the individual takes during the course of a meal. Regardless of desired weight loss, the number of bites per meal may be limited, for example, to 12 for small meals/snacks and 25 for lunch/dinner.

A problem with this method is that individuals attempting to follow the method frequently lose count of the number of bites taken. Distractions such as social conversation may cause the individual to lose count. The device enables an individual to track bites while engaging in stimulating repartee at the dinner table.

### OBJECTS OF THE INVENTION

It is an object of the present invention to provide a method and/or an associated device that facilitates the counting of bites during a meal.

Another object of the present invention is to provide such a method and/or device that is easy to use.

Another object of the invention is to help the individual eliminate stomach distress from over-consumption

A further object of the present invention is to provide such a method and/or device that may be unobtrusive or the total opposite: a conversation focus with other people present during a meal who are also interested in reducing consumption.

A further object of this invention is to enable an individual to increase his or her awareness beyond a meal or a day and provide a view of the entire week so that the individual can more easily reduce daily food intake.

These and other objects of the present invention will be apparent from the drawings and descriptions herein. While every object is attained by one or more embodiments of the invention, there is not necessarily an embodiment that achieves all of the objects of the invention.

### SUMMARY OF THE INVENTION

The present invention seeks to control food consumption by increasing a person's awareness of the amount of food he or she consumes and facilitating the person's attempts to limit food intake.

A weight control method in accordance with the present invention utilizes an electronic counting device. The method comprises placing bite-size amounts of comestible material in a one's mouth and actuating or activating a designated input element of the counting device each time a bite of comestible material in placed in one's mouth. The actuating or activating of the designated input element is implemented by touching the designated input element with a finger. The method further comprises operating the counting device to increment a counter each time the designated input element is actuated or activated and operating the counting device to automatically provide an alert signal to the user upon attainment of a predetermined bite number in the counter.

The electronic counting device may operate to generate a sound effect such as an apple crunching sound during the counting process. When the bite count approaches a pre-established maximum—12 bites for a snack and 25 bites for a meal—the apple crunch sound changes, for example, to a screech. In addition, the device may have a display showing a scale graphic characterized by a given color such as white during the counting process with the displayed color of the scale changing from white to yellow to orange to red after the pre-established maximum count is reached and attained. Additionally or alternatively, the scale graphic may take the form of an old mechanical weight scale where the metric moves (in rotation) to show numerals of increasing value as an increasing amount of weight is placed on the scale.

The display may be a touch screen or an LCD or LED display. As indicated above, the method may then further comprise operating the counting device to provide a predetermined message on the display in accordance with a number of bites recorded in the counter. The message typically includes an alphanumeric indication of the number of bites recorded in the counter. And a written message includes an observation or directive such as “Try chewing—slowly” or “Keep chewing—pause and breathe” or “Your stomach is stretching.”

Pursuant to an optional feature of the invention, the method may further comprise operating the counting device to monitor a rate at which bites are entered into the counter and, upon the counting device detecting a rate higher than a pre-established threshold, to provide a prompt on the display for the user to chew more slowly. Such a prompt is “Try chewing—slowly.”

The designated input element may be (i) a key element (push button or touch pad) of a keyboard or keypad or (ii) an area of a touch screen. The actuating or activating of the designated input element then consists of pressing the key or touching the screen.

In accordance with an additional feature of the present invention, the method also comprises operating the counting device to maintain a record of bites recorded in the counter at different sessions over time and operating the counting device to produce on the display a history of food consumed in the form of bites taken by the user. The history may take any convenient form, such as a bar graph. The electronic device may be programmable so that the user may select a daily food intake allowance in accordance with the user's caloric energy use.

Pursuant to another feature of the present invention, the counting device is operated to generate an audible signal each time the designated input element is actuated or activated, with the audible signal varying in accordance with a number of bites recorded in the counter. As discussed above, the sound generated may vary from an apple crunching sound to a screech or other alert signal. Preferably, the user may turn off the sound generator and later re-activate it as desired. In a more basic form, a generated sound may change in tone or beat rate or loudness depending on the number of bites recorded.

Pursuant to yet another feature of the present invention, the method further includes (a) entering into the counting device, prior to an initial placement of comestible material into the user's mouth, an identification of an expected magnitude of total food consumption of the sequence, and (b) operating the counting device to automatically select the predetermined number of bites from a plurality of bite numbers in accordance with the entered identification of expected total food consumption. This feature contemplates, for example, that the user might press one key to indicate that a snack is contemplated and another key to indicate that a full meal is on the table.

An electronic device for use in weight control comprises, in accordance with the present invention, a hand-held casing, a counter, an input element, and at least one feedback or output unit. The counter is disposed in the casing, while the input element is disposed on the casing and is operatively connected to the counter to increment contents of the counter each time a user actuates or activates the input element. The feedback or output unit is mounted to the casing and is operatively connected to the counter for providing a verbal message to the user that varies in accordance with counter contents.

In accordance with another feature of the present invention, a rate monitor is disposed in the casing and is operatively connected to the counter for monitoring a rate at which the counter is incremented. The rate monitor is operatively connected to the feedback or output unit for providing a predetermined prompt to the user upon detecting a rate higher than a pre-established maximum. The prompt may take the form of a verbal exhortation to the user to chew more slowly.

The electronic weight control device optionally includes a history/tracking component disposed in the casing and operatively connected to the counter to maintain a record of counts incurred at different sessions over time. The history-tracking component is operatively connected to the display to show a history of counter counts over different days.

In accordance with another feature of the present invention, the feedback or output unit of the electronic weight control device includes an audio signal generator mounted to the casing and operatively connected to the counter at least in part for automatically providing audio signals to the user that vary in accordance with counter contents. The electronic device may include a microprocessor that is programmed or a memory unit that stores instructions to activate the audio generator to generate different types of audio signals depending on how many bites the user has taken and the type of food intake session selected by the user. The audio signal may comprise a simple tone that increases in frequency as the number of bites approaches a predetermined limit for the type of food intake session selected by the user.

The electronic device may be provided with a physical or touch-screen keypad that enables a user to make a selection as to the type of food-consumption session. The available selections may simply consist of meal and snack. In that case, the keypad may exhibit a first key for selecting a snack and a second key for selecting a meal. Alternatively, the keypad may be a single key that is touched once for one selection (e.g., a snack) and twice for another selection (e.g., a meal). The selection key may be the same as the counter incrementation input element, with the microprocessor prompting the user via a display to select a type of food-intake session or to count bites.

A method and associated electronic device in accordance with the present invention provides a user with messages about chewing and breathing and slowing down so the user is not prone to heartburn and gas.

The tapping motion of the user in interaction with the electronic counting device causes the user to focus on what the user is doing and how fast the user is consuming food during the eating event. Increased awareness itself militates against overeating.

In addition, the historical or record-keeping feature of the present invention enables an individual to increase his or her awareness beyond a meal or a day and provides a view of the entire week so that the individual can more easily reduce daily food intake. This reduction is ultimately achieved by limiting the daily number of bites and the time of each so that one can reduce the number of times and the amount eaten if one overdoes it in a day.

### BRIEF DESCRIPTION OF THE DRAWINGS

FIG. 1 is a front elevational view of a handheld hard-wired or dedicated electronic device in accordance with the present invention, for increasing a person's awareness of the amount of food he or she consumes and facilitating the person's attempts to limit food intake.

FIG. 2 is a front elevational view of a handheld touch-screen electronic device in accordance with the present invention, showing a screen used in a bite counting method in accordance with the invention.

FIG. 3 is a block diagram of functional components of an electronic device in accordance with the present invention, for use in a bite-counting method in accordance with the invention.

### DETAILED DESCRIPTION

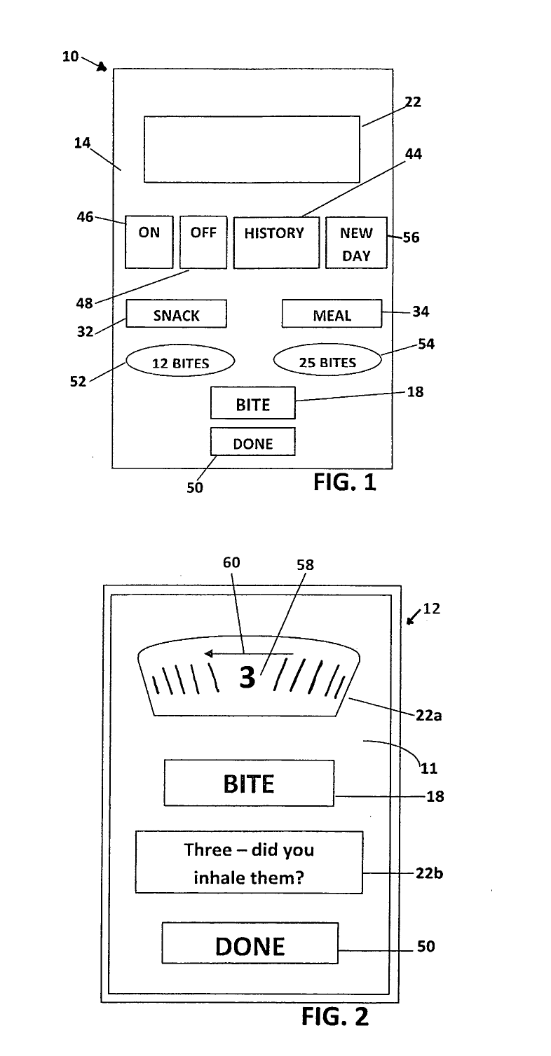

FIGS. 1 and 2 depict related handheld electronic devices 10 and 12 either of which a user operates to control food consumption by increasing the user's awareness of the amount of food he or she consumes and facilitating the user's attempts to limit food intake. Electronic device 12 has a touch screen 11, which when operating under an appropriate applications program provides interactive input areas and one or more display or message-providing areas. Device 10 is a dedicated hard-wired device that carries out the same functions as device 12.

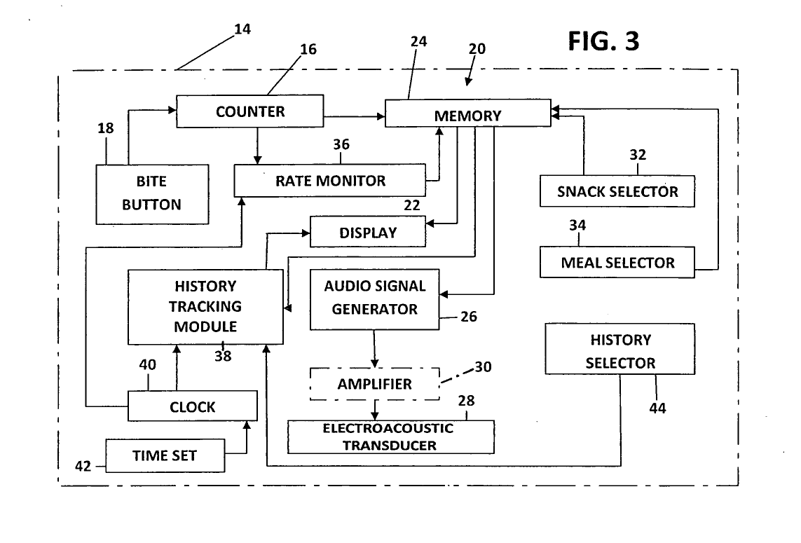

FIG. 3 is a functional block diagram of a generic handheld device realizable in the form of hard-wired device 10 or touch screen device 12. It is to be understood that the various functional blocks of FIG. 3 may be implemented by generic microprocessor components configured by programming to carry out the described functions.

As illustrated in FIG. 3, a device for assisting a user in controlling food consumption comprises a hand-held casing 14, a counter 16, an input element or “bite button” 18, and a visual feedback or output unit 20 including a display 22. Counter 16 is disposed inside casing 14, while bite button 18 is disposed on the casing and is operatively connected to counter 16 to increment contents thereof each time a user actuates or activates the bite button. The user activates the input element or bite button 18, by touching the input element with a finger, each time the user takes a bite of food during a snack session or during a meal.

Feedback or output unit 20 is mounted to casing 14 and is operatively connected to counter 16 for providing a verbal message to the user that varies in accordance with counter contents. To that end, feedback or output unit 20 includes a memory 24 that is operatively connected to counter 16 and to display 22 for providing a signal to display 22 in response to the numerical contents of counter 16. The signal encodes a verbal message that changes from one bite count to the next and that is shown on display 22. The following is a list of verbal messages corresponding to the integer contents of counter 16.
0. Bon Appetit!
1. Food, Glorious Food!!
2. Two bites down.
3. Three . . . did you inhale them?
4. Everyone eats the first few too fast.
5. Slow down for the next three.
6. Better, but slow it even more.
7. Try chewing. Slowly.
8. No need to take a bigger bite.
9. Bigger bites=more calories.
10. More quantity=a bigger stomach.
11. Sipping your beverage?
12. Fluids enhance flavor.
13. Keep chewing. Pause and breathe.
14. Inhale. Exhale. Pause.
15. In the home stretch.
16. Really chew each bite.
17. Taste this bite too.
18. Try chewing on the other side.
19. Other side feel strange?
20. Rest now. Feeling full yet?
21. It may be time to stop.
22. OK. So another bite.
23. Remember, 25 is the max.
24. Eat slowly and you'll feel fuller.
25. Wrap it up and eat it later.
26. There's no clean plate club here!
27. Your stomach is stretching.
28. Your digestive system is over-working.
29. You're wearing out your body . . . .
30. You're gaining pounds.
31 et seq. You're gaining pounds.

As further illustrated in FIG. 3, feedback or output unit 20 includes an audio signal generator 26 mounted to casing 14 and operatively connected to counter 16 via memory 24 at least in part for automatically providing audio signals to the user that vary in accordance with counter contents. Memory 24 stores the audio signals in digitally encoded form, while audio signal generator 26 includes a digital-to-analog converter for producing an analog output signal that is delivered to an electro-acoustic transducer or speaker 28 via an amplifier 30.

The electronic device shown in FIG. 3 may include a microprocessor (not separately illustrated) that includes memory 24 or is programmed to interact with memory 24 to produce verbal messages via display 22 and audio messages or alert signals via electro-acoustic transducer 28. In that case, memory 24 stores the instructions executed by the microprocessor to activate display 22 and audio generator 26.

The verbal messages show on display 22 and the audio signals generated via electro-acoustic transducer 28 may change not only in accordance with how many bites the user has taken (as recorded in counter 16) but also in accordance with the type of food intake session selected by the user. To that end the electronic device includes a pair of buttons or input selectors 32 and 34 that are alternatively engaged by a user to inform the microprocessor or memory 24 that the user intends to eat a snack (selector 32) or a meal (selector 34). The series of verbal messages retrieved from memory 24 for a snack selection (activation of button 32) in response to the contents of counter 16 may include the following specific entries.
0. Snack Time!
1. Food is Fuel.
2. Food is Fun.
3. Chew it. Slowly.
4. Inhale. Exhale.
5. Chew More.
6. Feeling recharged?
7. Focus on taste.
8. Breathe. Chew. Rest.
9. Have some fluid.
10. Now another bite.
11. Feel satiated?
12. Snack time is over!
13. Time to stop. (Yellow)
14. Another bite? (Orange)
15. Really, another one?? (Red)
16. More bites now . . . (Red)
17. Fewer bites later. (Red)
18. More-bites now . . . (Red)
19. Fewer bites later. (Red)
20. Stop. (Red)
21. Stop! (Red)
22. Stop!! (Red)
23. STOP!!! (Red)
24. Next time call it a meal. (Red)

As parenthetically indicated in the above list, display 22 may be a color display that provides a color-coded alert signal depending on the number of bites taken relative to a recommended target of 12 bites per snack and 25 bites per meal.

The audio signal produced by generator 26 in response to an input signal from memory 24 (or a microprocessor incorporating memory 24) may comprise a simple tone that increases in frequency as the number of bites approaches the predetermined limit of 12 snack bites or 25 meal time bites. Preferably, the audio signal changes from an apple crunching sound when the bite is below the bite limit to a screeching sound if the bite limit is exceeded. Other audio accompaniment, depending on the effect desired, will be apparent to those skilled in the art. For instance, it may be felt that a sound of waves breaking or leaves rustling would entice a user to chew more leisurely and with greater awareness. Optionally, the electronic device may be programmable to enable the user to select different verbal messages and/or different sound effects. Possibly, the verbal messages and audio accompaniments may vary randomly, automatically, to facilitate the user's continued awareness of food consumption.

As further depicted in FIG. 3, the electronic device for enhancing one's awareness of personal food consumption may optionally incorporate a bite-rate monitor 36 disposed in casing 14 and operatively connected to counter 16 for monitoring a rate at which the counter is incremented. Rate monitor 36 is operatively connected to feedback or output unit 20 for providing a predetermined prompt to the user upon detecting a rate higher than a pre-established maximum. More specifically, rate monitor 36 is connected to memory 24 for inducing the same to provide a predetermined verbal message on display 22 or an appropriate audio message via signal generator 26 and electro-acoustic transducer 28. Typically, the prompt takes the form of a verbal exhortation to the user to chew more slowly. Such a verbal message (examples in the above-presented list) would take the place of another preprogrammed message.

As additionally depicted in FIG. 3, the electronic device for enhancing one's awareness of personal food consumption may optionally incorporate a history-tracking module 38 disposed in casing 14 and operatively connected to counter 16 to maintain a record of counts incurred at different food-consumption sessions. To that end, history-tracking module 38 is operatively connected at an input to a clock 40, which may be reset by the user via an input element 42. History-tracking component 38 is operatively connected to display 22 to show a history of counter counts over different days. The user activates history-tracking module 38 via a history function selector 44 in the form of a dedicated input element. The displayed history may take any desirable form, for example, a bar graph.

The components shown in FIGS. 1 and 2 that are discussed above with reference to FIG. 3 are designated by the same reference numerals as used in FIG. 3. FIG. 1 also shows on and off control inputs 46 and 48 and a “done” button or input element 50. The actuation of off control input 48 or done button 50 trigger the storage of current counter contents and date/time information by history-tracking module 38 and the resetting of counter 16. Off control input 48 may have additional effects such as disconnecting a power supply (not shown).

As further depicted in FIG. 1, device 10 may be also equipped with ancillary displays 52 and 54 respectively associated with snack selector 32 and meal selector 34 for indicating the target number of bites for those different types of food consumption sessions. The target bites numbers shown on displays 52 and 54 may be fixed at the time of manufacture (displays being merely labels) or may be selectively changeable by the user. Electronic device 12 may also exhibit a day changeover button 56 that instructs the device for history tracking purposes that following bite counting sessions are in a new day.

As indicated above, while electronic device 10 has a fixed or dedicated keyboard or keypad with push button type elements, electronic device 12 has a touch-screen 11 which may display a keypad in any desirable configuration, including that of FIG. 1. Electronic device 12 may be a telephone, personal digital assistant, or other handheld electronic device that operates under an applications program to provide the input and display functions described hereinabove with reference to FIG. 3.

FIG. 2 shows a touch-screen configuration for use during bite counting. Display 22 is partitioned into two display sections 22a and 22b. Display section 22a has the geometrical configuration of a weight window of a conventional mechanical weight scale and shows a bite count, designated by reference numeral 58, and a plurality of weight scale gradation marks 60. Upon an actuation of bite button 18 (an area of the touch screen 14), the weight scale graphic moves as indicated by arrow 62 to display a new bite number. Display section 22b provides the succession of verbal messages described above that are keyed to the different bite counts.

The applications program that controls the bite-counting functions in electronic device 12 may configure touch screen 11 to implement snack selector 32 and meal selector 34 as well as history selector 44 and new day selector 58.

Other ways of implementing the functions described hereinabove with reference to FIG. 3 and other keyboard and display configurations will be apparent to those skilled in the art. For instance, the functions of snack selector 32 and meal selector 34 may be implemented in device 10 (or 12) by a single key that is touched once for one selection and twice for another selection. Display 22 may instruct the user as to the protocol. Moreover, the selection key may be the same as the counter incrementation input element, with the microprocessor prompting the user via a display to select a type of food-intake session or to count bites. Clearly, touch screen 11 and the programmability of device 12 easily enables a broad range of options as to keypad and display configurations and functionality.

During use of electronic counting device 10 or 12, the user places bite-size amounts of comestible material in his or her mouth and each time actuates or activates bite button input element 18. Upon the actuating or activating of bite button input element 18, e.g., with a finger, the counting device 10 or 12 increments counter 16. Counting device 10 or 12 automatically provides an alert signal to the user upon attainment of a predetermined bite number in the counter. As indicated above, the alert signal may include a message on display 22, 22b such as “Snack time is over!” and/or an audible signal. As indicated above, counting device 10, 12 preferably produces via memory 14 (with or without microprocessor control circuitry), signal generator 26, amplifier 30, and transducer 28 an audible sound upon each activation of bite button imputer element 18. The sound effect may be an apple crunching sound during the counting process. When the bite count approaches a pre-established maximum—12 bites for a snack and 25 bites for a meal—the apple crunch sound changes, for example, to a screech.

In addition, display 22, 22a may show a scale graphic characterized by a given color such as white during the counting process with the displayed color of the scale changing from white to yellow to orange to red as the pre-established maximum count is approached and attained. As to display section 22a, the scale graphic may take the form in an old mechanical weight scale where the scale display moves (in rotation) as an increasing amount of weight is placed on the scale.

As indicated above, counting device 10, 12 may be operated to provide a predetermined message on display 22, 22b in accordance with a number of bites recorded in counter 16. The message typically includes an alphanumeric indication 58 of the number of bites recorded in the counter.

Rate monitor 36 of counting device 10, 12 operates to determine the rate at which bites are entered into counter 16 and, upon detecting a rate higher than a pre-established threshold, to provide a prompt on display 22, 22b for the user to chew more slowly. See messages associated with meal bites 3 through 7 above.

History tracking module 38 of counting device 10, 12 operates to maintain a record of bites recorded in counter 16 at different sessions over time and produces on display 22 or touch screen 11 (a display) a history of food consumed or bites taken by the user. The history may take any convenient form, such as a bar graph. The electronic device may be programmable so that the user may select a daily food intake allowance in accordance with the user's caloric energy use.

Snack selector 32 and meal selector 34 enable a user to enter into counting device 10, 12 prior to an initial placement of comestible material into the user's mouth, an identification of an expected magnitude of total food consumption of the sequence. Counting device 10, 12 is programmed via memory 24 to automatically select the predetermined number of bites from a plurality of bite numbers in accordance with the entered identification of expected total food consumption.

Device 10, 12 provides a user with messages about chewing and breathing and slowing down so the user is not prone to heartburn and gas. A breathing button may be also provided for purposes of increasing the user's awareness of the breath and instilling a calming effect. The user presses the breath button each time the user inhales or exhales.

Although the invention has been described in terms of particular embodiments and applications, one of ordinary skill in the art, in light of this teaching, can generate additional embodiments and modifications without departing from the spirit of or exceeding the scope of the claimed invention. It is to be understood, for instance, that the various functional units or modules shown in FIG. 3 may be realized by generic microprocessor circuits modified by programming to carry out the intended functions. Accordingly, it is to be understood that the drawings and descriptions herein are proffered by way of example to facilitate comprehension of the invention and should not be construed to limit the scope thereof.

What is claimed is:

1. A method for weight control, comprising:
providing an electronic counting device;
placing a series of small amounts or bites of comestible material in a user's mouth;
actuating or activating a designated input element of said counting device each time a bite of comestible material in placed in the user's mouth, the actuating or activating of said designated input element including touching said designated input element with a finger;
operating said counting device to increment a counter each time said designated input element is actuated or activated; and
operating said counting device to automatically provide an alert signal to the user upon attainment of a predetermined bite number in said counter.

2. The method defined in claim 1 wherein said counting device is provided with a display, further comprising operating said counting device to provide a predetermined message on said display in accordance with a number of bites recorded in said counter.

3. The method defined in claim 2 wherein said message includes an alphanumeric indication of the number of bites recorded in said counter.

4. The method defined in claim 3 wherein said alphanumeric indication includes an integer positioned in the manner of a weight number on a weight scale graphic.

5. The method defined in claim 4 wherein said message includes a graphic of a mechanical weight scale, said graphic changing to simulate motion of said mechanical weight scale upon an incrementing of said counter.

6. The method defined in claim 2 wherein said message includes a verbal message that varies in accordance with the number of bites recorded in said counter.

7. The method defined in claim 2, further comprising operating said counting device to monitor a rate at which bites are entered into said counter and, upon said counting device detecting a rate higher than a pre-established threshold, to provide a prompt on said display for the user to chew more slowly.

8. The method defined in claim 1 wherein said counting device is a handheld electronic device, further comprising activating or turning on said electronic device prior to the actuating or activating of said designated input element.

9. The method defined in claim 8 wherein said designated input element is taken from the group consisting of (i) a key element of a keyboard or keypad and (ii) an area of a touch screen, the actuating or activating of the designated input element consisting of pressing the key element or touching the screen.

10. The method defined in claim 1, further comprising:
operating said counting device to maintain a record of bites recorded in said counter as a function of time; and
additionally operating said counting device to produce on said display a history of food consumed or bites taken by the user.

11. The method defined in claim 1, further comprising operating said counting device to generate an audible signal each time said designated input element is actuated or activated, said audible signal varying in accordance with a number of bites recorded in said counter.

12. The method defined in claim 1, further comprising:
entering into said counting device, prior to an initial placement of comestible material into the user's mouth, an identification of an expected magnitude of total food consumption of said sequence; and
operating said counting device to automatically select said predetermined number of bites from a plurality of bite numbers in accordance with the entered identification of expected total food consumption.

13. An electronic device for weight control, comprising:
a hand-held casing;
a counter in said casing;
an input element on said casing, said input element being operatively connected to said counter to increment contents of said counter each time a user actuates or activates said input element; and
at least one feedback or output unit mounted to said casing and operatively connected to said counter for providing a verbal message to the user that varies in accordance with counter contents.

14. The device defined in claim 13 wherein said feedback or output unit is configured to display a mechanical weight scale graphic with a numerical weight corresponding to the number of bites recorded in said counter.

15. The device defined in claim 14 wherein said feedback or output unit is configured to so display said weight scale graphic as to simulate motion of a mechanical scale.

16. The device defined in claim 13, further comprising a rate monitor disposed in said casing and operatively connected to said counter for monitoring a rate at which said counter is incremented, said rate counter being operatively connected to said at least one feedback or output unit for providing a predetermined prompt to the user upon detecting a rate higher than a pre-established maximum.

17. The device defined in claim 13, further comprising a history tracking component disposed in said casing and operatively connected to said counter to maintain a record of counts incurred at different sessions over time, said history tracking component being operatively connected to said display to show a history of counter counts over different days.

18. The device defined in claim 13 wherein said at least one feedback or output unit includes an audio signal generator mounted to said casing and operatively connected to said counter for automatically providing audio signals to the user that vary in accordance with counter contents.

19. The device defined in claim 13 wherein said input element is taken from the group consisting of (i) a key element of a keyboard or keypad and (ii) an area of a touch screen.
